(19) United States
(12) Patent Application Publication
(10) Pub. No.: US 2017/0068868 A1
(43) Pub. Date: Mar. 9, 2017

(54) ENHANCING HANDWRITING RECOGNITION USING PRE-FILTER CLASSIFICATION

(71) Applicant: Google Inc., Mountain View, CA (US)

(72) Inventors: Victor Carbune, Zurich (CH); Thomas Deselaers, Zurich (CH); Daniel M. Keysers, Stallikon (CH)

(21) Appl. No.: 14/849,162

(22) Filed: Sep. 9, 2015

(51) Int. Cl. G06K 9/22; G06F 17/27

(52) U.S. Cl. CPC G06K 9/222; G06F 17/275

(57) ABSTRACT

Methods, systems, and devices, including computer programs encoded on a computer storage medium, for improving handwriting detection. In one aspect, a method includes receiving data indicating one or more strokes, determining one or more features of the one or more strokes, determining whether the one or more strokes likely represent a grapheme based at least on one or more of the features, selecting a particular recognition process for processing the data, from among (i) a multi-language recognition process which processes input strokes using multiple recognizers that are each trained to output, for a given set of input strokes, one or more graphemes that are associated with a particular language, and (ii) a single character, universal recognition process which processes input strokes using a universal recognizer that is trained to output, for a given set of input strokes, a single grapheme, and providing the data to the particular recognition process.

### FIELD

The present specification relates to handwriting recognition.

### BACKGROUND

Users often provide handwriting input, such as by drawing symbols, doodles or scribbles, to experiment with the recognition capabilities of a handwriting recognition (HR) system. When a user provides a handwriting input, the HR systems attempts to interpret the strokes of the input as a valid sequence of characters.

### SUMMARY

When a handwriting input to a HR system includes different types of symbols, HR systems often exhibit poor recognition capabilities because of the lack of support for a variety of miscellaneous symbols, or because of constraints that require HR to be performed in a fast and resource-efficient manner. When different types of symbols are input, HR systems may output meaningless recognition results that often have little value to users that use handwriting input as a method of entering text into electronic devices. Furthermore, when the recognition process is performed on input strokes, which are patterns included within a handwriting input, that represent scribbles, processing may be computationally expensive because the input may include a large number of strokes, and because the arrangement of the strokes may not easily correspond to a recognized symbol.

Accordingly, one innovative aspect of the subject matter described in this specification can be embodied in methods that using multi-language recognition systems to initially classify different types of handwriting input and then handle the different types of handwriting input using particular recognition processes that are more effective in generating recognition results. For instance, features of the input strokes may be analyzed to determine if the strokes represent a grapheme, which represents the smallest unit used in describing a writing system of a language, or if the strokes represent scribbles, which are random concatenations of handwritten strokes or dots. The input may then be handled using different recognition processes based on whether the strokes represent a grapheme or a scribble. Although this specification generally describes a particular implementation that includes determining whether input strokes represent graphemes, in other implementations, methods may include determining whether input strokes represent other typographical features such as glyphs, allographs, characters, symbols, or drawings,

Handwriting input classification and filtering may be used to improve the overall recognition performance of a HR system to improve user experience. For example, the time to generate a recognition result may be reduced by using particular recognition processes adapted to the different types of handwriting input, e.g., different languages. In other examples, recognition result generation may use fewer computational resources, and the more accurate recognition results may be provided. More particularly, handwriting input classification and filtering may also be used to handle peculiar handwriting inputs such as drawings and symbols that are usually more difficult to recognize compared to text input.

Implementations may include one or more of the following features. For example, a computer-implemented method may include: receiving data indicating one or more strokes; determining one or more features of the one or more strokes; determining whether the one or more strokes likely represent a grapheme based at least on one or more of the features; selecting a particular recognition process for processing the data, from among at least (i) a multi-language recognition process which processes input strokes using multiple recognizers that are each trained to output, for a given set of input strokes, one or more graphemes that are associated with a particular language, and (ii) a single character, universal recognition process which processes input strokes using a universal recognizer that is trained to output, for a given set of input strokes, a single grapheme; and providing the data for processing using the particular recognition process.

In other implementations, a computer-implemented method may include: receiving data indicating one or more strokes; determining one or more features of the one or more strokes; determining whether the one or more strokes likely represent a grapheme based at least on one or more of the features; selecting a particular recognition process for processing the data, from among at least (i) a single language recognition process which processes input strokes using a single recognizer that is trained to output, for a given set of input strokes, one or more graphemes that are associated with a particular language, and (ii) a single character, universal recognition process which processes input strokes using a universal recognizer that is trained to output, for a given set of input strokes, a single grapheme; and providing the data for processing using the particular recognition process.

Other versions include corresponding systems, and computer programs, configured to perform the actions of the methods encoded on computer storage devices.

One or more implementations may include the following optional features. For example, in some implementations, determining whether the one or more strokes likely represent a grapheme includes determining that the one or more strokes likely represent a grapheme, and where selecting the particular recognition process for processing the data includes selecting the multi-language recognition process.

In some implementations, determining whether the one or more strokes likely represent a grapheme includes determining that the one or more strokes does not likely represent a grapheme, and where selecting the particular recognition process for processing the data includes selecting the single character, universal recognition process.

In some implementations, the method may include, where the multi-language recognition process further processes input strokes, using the universal recognizer that is trained to output, for a given set of input strokes, a single grapheme.

In some implementations, determining whether the one or more strokes likely represent a grapheme includes generating a confidence score representing the likelihood that the one or more strokes represents a grapheme, and where the particular recognition process is selected based at least on the generated confidence score.

In some implementations, selecting the particular recognition process for processing the data includes selecting a subset of the multiple recognizers to output the data indicating the one or more strokes.

In some implementations, determining whether the one or more strokes likely represent a grapheme includes determining whether the one or more strokes represents a scribble or a scratch.

The details of one or more implementations are set forth in the accompanying drawings and the description below. Other potential features and advantages will become apparent from the description, the drawings, and the claims.

Other implementations of these aspects include corresponding systems, apparatus and computer programs, configured to perform the actions of the methods, encoded on computer storage devices.

### BRIEF DESCRIPTION OF THE DRAWINGS

FIG. 1 is a diagram that illustrates an example system for improving handwriting recognition.

FIG. 2 illustrates an example process for processing one or more data indicating one or more strokes.

FIG. 3 is a block diagram of computing devices on which the processes described herein, or potions thereof, may be implemented.

In the drawings, like reference numbers represent corresponding parts throughout.

### DETAILED DESCRIPTION

One innovative aspect of the subject matter described in this specification can be embodied in processes that classify and filter different types of handwriting input and handle the different types of handwriting input using respective recognition processes that more efficiently handle those individual types of inputs.

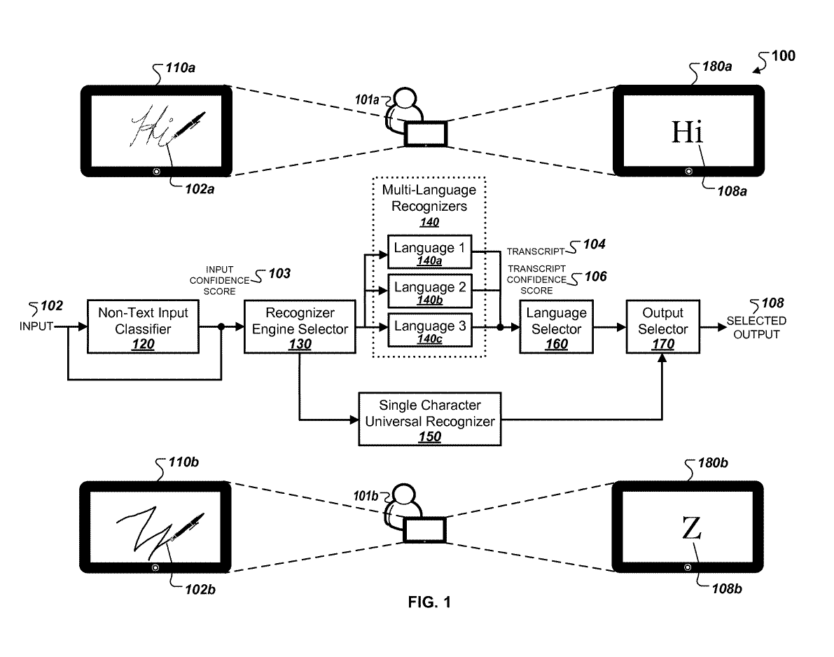

FIG. 1 is a diagram that illustrates an example system 100 for improving handwriting recognition. Briefly, the system 100 may receive an input 102, e.g., inputs 102a and 102b, and provide an output 108, e.g., outputs 108a and 108b, which are the handwriting recognition results of the input 102. In some instances, the system 100 may calculate an input confidence score 103, a transcript 104, and a transcript confidence score 106. The system 100 may also include components such as a non-text input classifier 120, a recognizer engine selector 130, multi-language recognizers 140 for languages 140a-140c, a single character universal recognizer 150, a language selector 160, an output selector 170.

Additionally, FIG. 1 represents an example of handwriting input classification and filtering. For instance, example users 101a-101b provide inputs 102a and 102b on the input device screens 110a and 110b, respectively. The outputs 108a and 108b are displayed on the output device screens 180a and 180b, respectively, which are the recognition results corresponding to the inputs 102a and 102b, respectively.

The non-text input classifier 120 may be a software module within a HR system that receives handwriting input such as the input 102. The non-text input classifier 120 may classify inks, which are collections of input strokes included in the received input 102, by initially pre-processing the input data and removing irrelevant data, e.g., signal noise, extraneous strokes, that may negatively impact handwriting recognition. In some instances, the non-text input classifier 120 may also perform additional pre-processing steps such as normalization, sampling, smoothing and de-noising to improve HR system speed and accuracy.

The non-text input classifier 120 may then extract features from the input 102. For instance, the non-text input classifier 120 may generate dimensional vector fields to extract information about the input 102. For example, extracted features may include aspect ratio, percent of pixels above horizontal half point, percent of pixels to right of vertical half point, number of strokes, stroke curvature, average distance from image center, pen pressure, pen velocity, time points between multiple input strokes, total time to provide input, or changes in writing direction. The non-text input classifier 120 may then use the extracted features to determine if the input strokes of the input 102 likely represent graphemes that are mapped to particular features.

In some implementations, the non-text input classifier 120 may be a light-weight two-class classifier that classifies the input 120 as either containing at least one recognizable grapheme or a scribble that does not include a recognizable grapheme. For instance, the non-text input classifier 120 may be a neural network that includes statistical learning modules trained to classify the input strokes based on the feature extraction. In other instances, the non-text input classifier 120 may be a support vector machine that includes associated learning algorithms that recognize and analyze patterns within input strokes for classification and regression analysis based on a set of training examples.

In some implementations, the non-text input classifier 120 may generate an input confidence score 103 representing the likelihood that the input strokes of the input 102 represents a grapheme. For instance, the input confidence score 103 may be based on the comparing the extracted features from the input 102 to representative features associated with a set of graphemes. In some instances, the generated input confidence score 103 for the input 102 may be compared to a threshold value to determine whether the input 102 likely represents a grapheme or a scribble. For example, if the input confidence score 103 for the input 102 is below the threshold value, then the input 102 may be classified as a scribble. In such examples, the threshold value may be precisely calculated based on training data such that the probability that the non-text input classifier 120 accidentally classifies an input 102 as a scribble is minimized. The training data may include particular inks and labels indicating whether the input strokes represent scribbles.

As shown in the example in FIG. 1, the users 101a and 101b may correspond to the users that provide separate handwriting inputs 102a and 102b, respectively on an input mobile device. The input mobile device may be any type of mobile computing device with an electronic visual display that can detect the presence and location of a handwriting input within the display area, such as a smartphone, a tablet computer, or a laptop screen.

The inputs 102a and 102b are handwriting inputs that are handled differently by the system 100. For example, the example input 102a includes features that represent at least one recognizable grapheme, e.g., “H” and “i,” which is likely to be determined by the system 100 to include a grapheme and are subsequently processed using a multi-language recognition process. In contrast, the example input 102b does not include features that represent a recognizable grapheme and are subsequently processed using a single, universal recognition process.

Once the input 102 is classified by non-text input classifier 120, the input 102 may then be transmitted to the recognizer engine selector 130. The recognizer engine selector 130 may select the particular recognition process to handle the input 102. For instance, as previously described, inputs that are classified as likely representing a grapheme may be handled by a multi-language recognition process that includes multi-language recognizers 140 for the languages 140a-140c, whereas the inputs that are classified as a scribble that does not represent a grapheme may be handled by a single character universal recognition process that includes the single character universal recognizer 150.

In some implementations, the operations of the non-text input classifier 120 and the recognizer engine selector 130 may be performed by a single software component of the system 100. For example, in such implementations, the recognizer engine selector 130 may also perform the operations of the non-text input classifier 120 and vice versa.

In instances where the input 102 is classified as representing a grapheme, the input 102 may be handled using multi-language recognizers 140 for various languages, e.g., the languages 140a-140c. For example, the recognizer engine selector 130 may initially determine a set of potential transcripts 104 corresponding to the languages 140a-140c that are included in the input 102. The detector engine 130 may then query the particular language recognizers 140 corresponding to each transcript 104 to handle the input 102. In some instances where a single input 102 includes multiple transcripts 104 that correspond to different languages, e.g., “los cat,” the detector engine may query multiple language recognizers 140 that correspond to the different languages. For example, the recognizer engine selector 130 may query the particular language recognizer 140 for language 140a, which may be Spanish, for the “los” portion of the input 102 as well as the particular language recognizer 140 for language 140b, which may be English, for the “cat” portion of the input 102.

In some implementations, the recognizer engine selector 130 may also generate a transcript confidence score 106 that corresponds the likelihood that the transcript 104 represents a high quality transcription for the input 102. For instance, if the input 102 includes an ambiguous segment such as “rope-eh” that may be transcribed into “rope” in English or “ropa” in Spanish, the recognizer engine selector 130 may generate a transcript confidence score 106 for each transcription that represents a low quality transcription for the input 102. In some instances, the recognizer engine selector 130 may use the transcript confidence score 106 to perform a pre-filtering step to discard low quality transcriptions to increase handwriting recognition speed, increase recognition quality, and lower the amount of computational resourced used. For example, the recognizer engine selector 130 may compare the transcript confidence score 106 to a threshold value and discard the transcripts 104 that have a transcript confidence score 106 below the threshold value.

In other instances where the input 102 is classified as a scribble, the input 102 may be handled using various processes. For example, in some implementations, the input 102 is handled using the single character universal recognizer 150. The single character universal recognizer 150 may be trained on a large set of Unicode code points that include text, e.g., letters and symbols. The single universal recognizer 150 may also process long inputs independently of the input size since it only handles scribble inputs.

In other implementations where the input 102 is classified as a scribble, the input 102 may be discarded to conserve computational resources within the HR system from processing an invalid recognition output. In other implementations, the input 102 may be handled using a particular recognition process that includes a specialized scribble recognizer that is trained using complex drawings and symbols such as, e.g., emojis, arrows. In other implementations, the input 102 may be handled by a multi-language recognition process in addition to the single character universal recognition process.

The language selector 160 may be a software module that selects the particular languages 140a-140c associated with each of the transcripts 104. For instance, the language selector may receive the transcripts 104 from the recognizer engine selector 130 and select the languages based on attributes of the transcripts 104. For example, the language selector 160 may parse a repository that maps transcript attributes to particular languages to determine the languages 140a-140c that are associated with the transcripts 104.

The language selector 160 may also select the particular language recognizers that are associated with each language. For instance, the language recognizers may be handwriting recognizers that are trained to handle handwriting input and generate recognition outputs using the particular languages.

The output selector 170 may receive one or more recognition outputs for the input 102 that are generated using either the multiple language recognizers for the languages 140a-140c or the single character universal recognizer 150. In some instances, the output selector 170 may receive a set of candidate recognition outputs for each of the languages 140a-140c for the input 102. In such instances, the candidate recognition outputs may represent alternative recognition outputs for a single input 102. In other instances where the input 102 includes different types of characters and symbols, the output selector 170 may receive recognition outputs from both the multi-language recognition process and the single character universal recognition process. In such instances, the multiple recognition outputs may represent outputs for segments of a single input 102.

In some implementations, the operations of the language selector 160 and the output selector 170 may be performed by a single software component of the system 100. For example, the language selector 160 may additionally perform the operations of the output selector 170 and vice versa. In other implementations, the results from the multi-language recognizers 140 may be merged such that only the output may need to be selected without selecting a particular language.

In instances where the system 100 generates alternative recognition outputs for the input 102, the output selector 170 may select the selected output 108 that best recognition of the input 102 using a combination of the input confidence score 103 and the transcript confidence score 106. In other instances where the system 100 generates multiple recognition outputs corresponding to segments of the input 102, the output selector 170 may select multiple recognition hypotheses to be included in the selected output 108. For example, if the input 102 includes two segments, a first a segment associated with text and a second segment associated with a drawing similar to a scribble, the output selector 170 may select a selected output 108 that includes a first recognition output corresponding to the text generated from the multi-language recognizers 140 and a second recognition output corresponding to the scribble generated from the single character universal recognizer 150.

As shown in the example in FIG. 1, the outputs 108a and 108b correspond to the separate handwriting inputs 102a and 102b, respectively, which are displayed on the output device screens 180a and 180b, respectively. For example, the output 108a is generated from the multi-language recognition process using the particular language recognizer 140 for the English language based on the input 102a including recognizable English graphemes “H” and “I.” In contrast, the output 108b is generated from the single character universal recognition process using the single character universal recognizer 150 based on the input 102b being classified as a scribble. The output 108b includes the grapheme “Z” since this is the single grapheme that most closely corresponds to the input strokes in the input 102b.

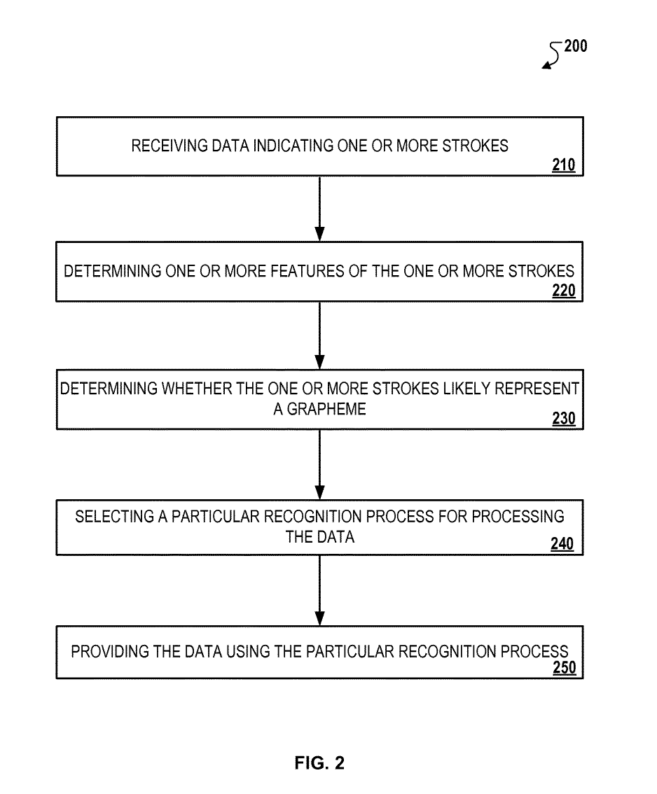

FIG. 2 illustrates an example process 200 for processing one or more data indicating one or more strokes. Briefly, the process 200 may include receiving data indicating one or more strokes (210), determining one or more features of the one or more strokes (220), determining whether the one or more strokes likely represent a grapheme (230), selecting a particular recognition process for processing the data (240), and providing the data using the particular recognition process (250).

In more details, the process 200 may include receiving data indicating one or more strokes (210). For example, the non-text input classifier 120 may receive the input 102 indicating one or more strokes. As shown in the example in FIG. 1, users 101a and 101b may provide the inputs 102a and 102b on the input devices 110a and 110b, respectively.

The process 200 may include determining one or more features of the one or more strokes (220). For example, the non-text input classifier 120 may extract features from the input 102 such as aspect ratio, percent of pixels above horizontal half point, percent of pixels to right of vertical half point, number of strokes, stroke curvature, average distance from image center, pen pressure, pen velocity, or changes in writing direction.

In some implementations, after determining the one or more features of the one or more strokes, the non-text input classifier 120 may generate an input confidence score 103 based on the one or more features of the one or more strokes of the input 102. For instance, the input confidence score 103 may be used to determine whether the one or more strokes likely represent a grapheme.

The process 200 may include determining whether the one or more strokes likely represent a grapheme based at least on one or more of the features (230). For example, the non-text input classifier 120 may classify the input 102 as either representing at least one recognizable grapheme or a scribble that does not represent at least one recognizable grapheme. As represented in the example in FIG. 1, the non-text input classifier 120 may classify the input 102a as a representing the graphemes “H” and “i,” and may classify the input 102b as representing a scribble because the strokes of the input 102b does represent a recognizable grapheme.

The process 200 may include selecting a particular recognition process for processing the data from at least a multi-language recognition process and a single character, universal recognition process (240). For example, the recognizer engine selector 130 may select a particular recognition process for the input 102 based on the classification of the input 102 by the non-text input classifier 120. For instance, the recognizer engine selector 130 may select the multi-language recognition process for the input 102a and may select the single character universal recognition process for the input 102b.

The process 200 may include providing the data for processing using the particular recognition process (250). For example, the recognizer engine selector 130 may select either the multi-language recognition process or the single character universal recognition process for the input 102. For instance, the recognizer engine selector 130 may select the multi-language recognition process for the input 102a and the single character universal recognition process for the user input 102b.

With respect to the multi-language recognition process for the input 102a, the multi-language recognizers 140 may be used to generate one or more graphemes corresponding to the languages 140a-140c. For example, the multi-language recognizers 140 may be each trained to output, for a given set of input strokes of the input 102, one or more graphemes that are associated with a particular language. In the example provided in FIG. 1, the input 102a may be handled using a particular language recognizer 140 for the English language based on the graphemes “H” and “I” being associated with the English language.

With respect to the single character, universal recognition process for the input 102b, the single character universal recognizer 150 may be used to generate a single grapheme. For example, the single character universal recognizer 150 may be trained to output, for a given set of input strokes of the input 102, a single grapheme. In the example provided in FIG. 1, the input 102b may be handled by the single character universal recognizer 150 to output the grapheme “Z,” which most closely resembles the input strokes of the input 102b.

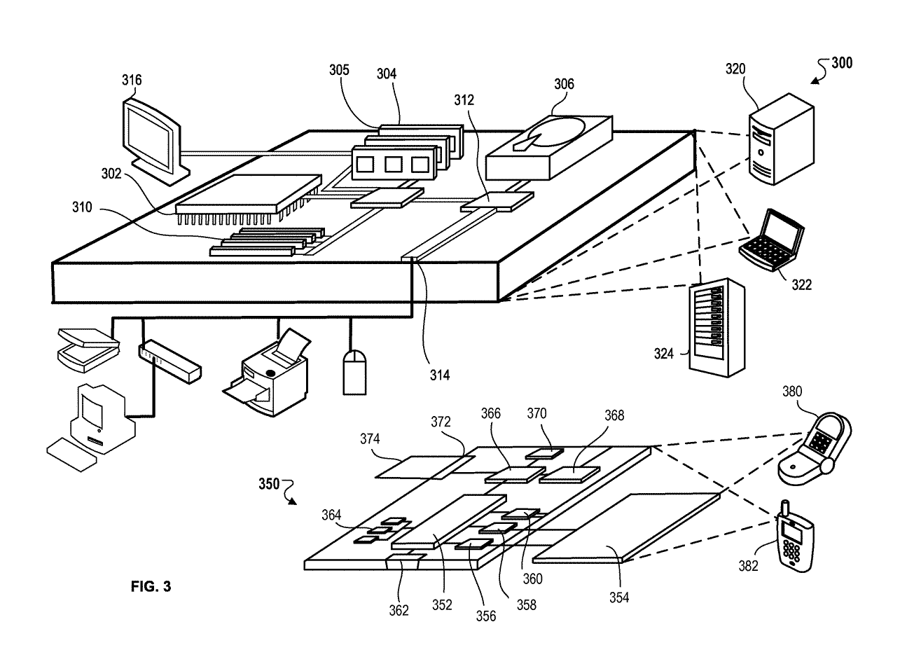

FIG. 3 is a block diagram of computing devices 300, 350 that may be used to implement the systems and methods described in this document, as either a client or as a server or plurality of servers. Computing device 300 is intended to represent various forms of digital computers, such as laptops, desktops, workstations, personal digital assistants, servers, blade servers, mainframes, and other appropriate computers. Computing device 350 is intended to represent various forms of mobile devices, such as personal digital assistants, cellular telephones, smartphones, and other similar computing devices. Additionally computing device 300 or 350 can include Universal Serial Bus (USB) flash drives. The USB flash drives may store operating systems and other applications. The USB flash drives can include input/output components, such as a wireless transmitter or USB connector that may be inserted into a USB port of another computing device. The components shown here, their connections and relationships, and their functions, are meant to be exemplary only, and are not meant to limit implementations of the inventions described and/or claimed in this document.

Computing device 300 includes a processor 302, memory 304, a storage device 306, a high-speed interface 308 connecting to memory 304 and high-speed expansion ports 310, and a low speed interface 312 connecting to low speed bus 314 and storage device 306. Each of the components 302, 304, 306, 308, 310, and 312, are interconnected using various busses, and may be mounted on a common motherboard or in other manners as appropriate. The processor 302 can process instructions for execution within the computing device 300, including instructions stored in the memory 304 or on the storage device 306 to display graphical information for a GUI on an external input/output device, such as display 316 coupled to high speed interface 308. In other implementations, multiple processors and/or multiple buses may be used, as appropriate, along with multiple memories and types of memory. Also, multiple computing devices 300 may be connected, with each device providing portions of the necessary operations, e.g., as a server bank, a group of blade servers, or a multi-processor system.

The memory 304 stores information within the computing device 300. In one implementation, the memory 304 is a volatile memory unit or units. In another implementation, the memory 304 is a non-volatile memory unit or units. The memory 304 may also be another form of computer-readable medium, such as a magnetic or optical disk.

The storage device 306 is capable of providing mass storage for the computing device 300. In one implementation, the storage device 306 may be or contain a computer-readable medium, such as a floppy disk device, a hard disk device, an optical disk device, or a tape device, a flash memory or other similar solid state memory device, or an array of devices, including devices in a storage area network or other configurations. A computer program product can be tangibly embodied in an information carrier. The computer program product may also contain instructions that, when executed, perform one or more methods, such as those described above. The information carrier is a computer- or machine-readable medium, such as the memory 304, the storage device 306, or memory on processor 302.

The high speed controller 308 manages bandwidth-intensive operations for the computing device 300, while the low speed controller 312 manages lower bandwidth intensive operations. Such allocation of functions is exemplary only. In one implementation, the high-speed controller 308 is coupled to memory 304, display 316, e.g., through a graphics processor or accelerator, and to high-speed expansion ports 310, which may accept various expansion cards (not shown). In the implementation, low-speed controller 312 is coupled to storage device 306 and low-speed expansion port 314. The low-speed expansion port, which may include various communication ports, e.g., USB, Bluetooth, Ethernet, wireless Ethernet may be coupled to one or more input/output devices, such as a keyboard, a pointing device, microphone/speaker pair, a scanner, or a networking device such as a switch or router, e.g., through a network adapter. The computing device 300 may be implemented in a number of different forms, as shown in the figure. For example, it may be implemented as a standard server 320, or multiple times in a group of such servers. It may also be implemented as part of a rack server system 324. In addition, it may be implemented in a personal computer such as a laptop computer 322. Alternatively, components from computing device 300 may be combined with other components in a mobile device (not shown), such as device 350. Each of such devices may contain one or more of computing device 300, 350, and an entire system may be made up of multiple computing devices 300, 350 communicating with each other.

The computing device 300 may be implemented in a number of different forms, as shown in the figure. For example, it may be implemented as a standard server 320, or multiple times in a group of such servers. It may also be implemented as part of a rack server system 324. In addition, it may be implemented in a personal computer such as a laptop computer 322. Alternatively, components from computing device 300 may be combined with other components in a mobile device (not shown), such as device 350. Each of such devices may contain one or more of computing device 300, 350, and an entire system may be made up of multiple computing devices 300, 350 communicating with each other.

Computing device 350 includes a processor 352, memory 364, and an input/output device such as a display 354, a communication interface 366, and a transceiver 368, among other components. The device 350 may also be provided with a storage device, such as a microdrive or other device, to provide additional storage. Each of the components 350, 352, 364, 354, 366, and 368, are interconnected using various buses, and several of the components may be mounted on a common motherboard or in other manners as appropriate.

The processor 352 can execute instructions within the computing device 350, including instructions stored in the memory 364. The processor may be implemented as a chipset of chips that include separate and multiple analog and digital processors. Additionally, the processor may be implemented using any of a number of architectures. For example, the processor 310 may be a CISC (Complex Instruction Set Computers) processor, a RISC (Reduced Instruction Set Computer) processor, or a MISC (Minimal Instruction Set Computer) processor. The processor may provide, for example, for coordination of the other components of the device 350, such as control of user interfaces, applications run by device 350, and wireless communication by device 350.

Processor 352 may communicate with a user through control interface 358 and display interface 356 coupled to a display 354. The display 354 may be, for example, a TFT (Thin-Film-Transistor Liquid Crystal Display) display or an OLED (Organic Light Emitting Diode) display, or other appropriate display technology. The display interface 356 may comprise appropriate circuitry for driving the display 354 to present graphical and other information to a user. The control interface 358 may receive commands from a user and convert them for submission to the processor 352. In addition, an external interface 362 may be provide in communication with processor 352, so as to enable near area communication of device 350 with other devices. External interface 362 may provide, for example, for wired communication in some implementations, or for wireless communication in other implementations, and multiple interfaces may also be used.

The memory 364 stores information within the computing device 350. The memory 364 can be implemented as one or more of a computer-readable medium or media, a volatile memory unit or units, or a non-volatile memory unit or units. Expansion memory 374 may also be provided and connected to device 350 through expansion interface 372, which may include, for example, a SIMM (Single In Line Memory Module) card interface. Such expansion memory 374 may provide extra storage space for device 350, or may also store applications or other information for device 350. Specifically, expansion memory 374 may include instructions to carry out or supplement the processes described above, and may include secure information also. Thus, for example, expansion memory 374 may be provide as a security module for device 350, and may be programmed with instructions that permit secure use of device 350. In addition, secure applications may be provided via the SIMM cards, along with additional information, such as placing identifying information on the SIMM card in a non-hackable manner.

The memory may include, for example, flash memory and/or NVRAM memory, as discussed below. In one implementation, a computer program product is tangibly embodied in an information carrier. The computer program product contains instructions that, when executed, perform one or more methods, such as those described above. The information carrier is a computer- or machine-readable medium, such as the memory 364, expansion memory 374, or memory on processor 352 that may be received, for example, over transceiver 368 or external interface 362.

Device 350 may communicate wirelessly through communication interface 366, which may include digital signal processing circuitry where necessary. Communication interface 366 may provide for communications under various modes or protocols, such as GSM voice calls, SMS, EMS, or MMS messaging, CDMA, TDMA, PDC, WCDMA, CDMA2000, or GPRS, among others. Such communication may occur, for example, through radio-frequency transceiver 368. In addition, short-range communication may occur, such as using a Bluetooth, WiFi, or other such transceiver (not shown). In addition, GPS (Global Positioning System) receiver module 370 may provide additional navigation- and location-related wireless data to device 350, which may be used as appropriate by applications running on device 350.

Device 350 may also communicate audibly using audio codec 360, which may receive spoken information from a user and convert it to usable digital information. Audio codec 360 may likewise generate audible sound for a user, such as through a speaker, e.g., in a handset of device 350. Such sound may include sound from voice telephone calls, may include recorded sound, e.g., voice messages, music files, etc. and may also include sound generated by applications operating on device 350.

The computing device 350 may be implemented in a number of different forms, as shown in the figure. For example, it may be implemented as a cellular telephone 480. It may also be implemented as part of a smartphone 382, personal digital assistant, or other similar mobile device.

Various implementations of the systems and methods described here can be realized in digital electronic circuitry, integrated circuitry, specially designed ASICs (application specific integrated circuits), computer hardware, firmware, software, and/or combinations of such implementations. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” “computer-readable medium” refers to any computer program product, apparatus and/or device, e.g., magnetic discs, optical disks, memory, Programmable Logic Devices (PLDs), used to provide machine instructions and/or data to a programmable processor, including a machine-readable medium that receives machine instructions as a machine-readable signal. The term “machine-readable signal” refers to any signal used to provide machine instructions and/or data to a programmable processor.

To provide for interaction with a user, the systems and techniques described here can be implemented on a computer having a display device, e.g., a CRT (cathode ray tube) or LCD (liquid crystal display) monitor for displaying information to the user and a keyboard and a pointing device, e.g., a mouse or a trackball by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

The systems and techniques described here can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the systems and techniques described here, or any combination of such back end, middleware, or front end components. The components of the system can be interconnected by any form or medium of digital data communication, e.g., a communication network. Examples of communication networks include a local area network (“LAN”), a wide area network (“WAN”), and the Internet.

The computing system can include clients and servers. A client and server are generally remote from each other and typically interact through a communication network. The relationship of client and server arises by virtue of computer programs running on the respective computers and having a client-server relationship to each other.

A number of embodiments have been described. Nevertheless, it will be understood that various modifications may be made without departing from the spirit and scope of the invention. In addition, the logic flows depicted in the figures do not require the particular order shown, or sequential order, to achieve desirable results. In addition, other steps may be provided, or steps may be eliminated, from the described flows, and other components may be added to, or removed from, the described systems. Accordingly, other embodiments are within the scope of the following claims.

What is claimed is:

1. A computer-implemented method comprising:
receiving data indicating one or more strokes;
determining one or more features of the one or more strokes;
determining whether the one or more strokes likely represent a grapheme based at least on one or more of the features;
selecting a particular recognition process for processing the data, from among at least (i) a multi-language recognition process which processes input strokes using multiple recognizers that are each trained to output, for a given set of input strokes, one or more graphemes that are associated with a particular language, and (ii) a single character, universal recognition process which processes input strokes using a universal recognizer that is trained to output, for a given set of input strokes, a single grapheme; and
providing the data for processing using the particular recognition process.

2. The method of claim 1, wherein:
determining whether the one or more strokes likely represent a grapheme comprises determining that the one or more strokes likely represent a grapheme, and
wherein selecting the particular recognition process for processing the data comprises selecting the multi-language recognition process.

3. The method of claim 1, wherein:
determining whether the one or more strokes likely represent a grapheme comprises determining that the one or more strokes does not likely represent a grapheme, and
wherein selecting the particular recognition process for processing the data comprises selecting the single character, universal recognition process.

4. The method of claim 2, wherein the multi-language recognition process further processes input strokes using the universal recognizer that is trained to output, for a given set of input strokes, a single grapheme.

5. The method of claim 2, wherein determining whether the one or more strokes likely represent a grapheme comprises generating a confidence score representing the likelihood that the one or more strokes represents a grapheme; and
wherein the particular recognition process is selected based at least on the generated confidence score.

6. The method of claim 2, wherein selecting the particular recognition process for processing the data comprises selecting a subset of the multiple recognizers to output the data indicating the one or more strokes.

7. The method of claim 1, wherein determining whether the one or more strokes likely represent a grapheme comprises determining whether the one or more strokes represents a scribble or a scratch.

8. A system comprising:
one or more computers; and
a non-transitory computer-readable medium coupled to the one or more computers having instructions stored thereon, which, when executed by the one or more computers, cause the one or more computers to perform operations comprising:
receiving data indicating one or more strokes;
determining one or more features of the one or more strokes;
determining whether the one or more strokes likely represent a grapheme based at least on one or more of the features;
selecting a particular recognition process for processing the data, from among at least (i) a multi-language recognition process which processes input strokes using multiple recognizers that are each trained to output, for a given set of input strokes, one or more graphemes that are associated with a particular language, and (ii) a single character, universal recognition process which processes input strokes using a universal recognizer that is trained to output, for a given set of input strokes, a single grapheme; and
providing the data for processing using the particular recognition process.

9. The system of claim 8, wherein:
determining whether the one or more strokes likely represent a grapheme comprises determining that the one or more strokes likely represent a grapheme, and
wherein selecting the particular recognition process for processing the data comprises selecting the multi-language recognition process.

10. The system of claim 8, wherein:
determining whether the one or more strokes likely represent a grapheme comprises determining that the one or more strokes does not likely represent a grapheme, and
wherein selecting the particular recognition process for processing the data comprises selecting the single character, universal recognition process.

11. The system of claim 9, wherein the multi-language recognition process further processes input strokes using the universal recognizer that is trained to output, for a given set of input strokes, a single grapheme.

12. The system of claim 9, wherein determining whether the one or more strokes likely represent a grapheme comprises generating a confidence score representing the likelihood that the one or more strokes represents a grapheme; and
wherein the particular recognition process is selected based at least on the generated confidence score.

13. The system of claim 9, wherein selecting the particular recognition process for processing the data comprises selecting a subset of the multiple recognizers to output the data indicating the one or more strokes.

14. The system of claim 8, wherein determining whether the one or more strokes likely represent a grapheme comprises determining whether the one or more strokes represents a scribble or a scratch.

15. A non-transitory computer storage device encoded with a computer program, the program comprising instructions that when executed by one or more computers cause the one or more computers to perform operations comprising:
receiving data indicating one or more strokes;
determining one or more features of the one or more strokes;
determining whether the one or more strokes likely represent a grapheme based at least on one or more of the features;
selecting a particular recognition process for processing the data, from among at least (i) a multi-language language recognition process which processes input strokes using a single recognizer that is trained to output, for a given set of input strokes, one or more graphemes that are associated with a particular language, and (ii) a single character, universal recognition process which processes input strokes using a universal recognizer that is trained to output, for a given set of input strokes, a single grapheme; and
providing the data for processing using the particular recognition process.

16. The device of claim 15, wherein:
determining whether the one or more strokes likely represent a grapheme comprises determining that the one or more strokes likely represent a grapheme, and
wherein selecting the particular recognition process for processing the data comprises selecting the multi-language recognition process.

17. The device of claim 15, wherein:
determining whether the one or more strokes likely represent a grapheme comprises determining that the one or more strokes does not likely represent a grapheme, and
wherein selecting the particular recognition process for processing the data comprises selecting the single character, universal recognition process.

18. The device of claim 16, wherein the multi-language recognition process further processes input strokes using the universal recognizer that is trained to output, for a given set of input strokes, a single grapheme.

19. The device of claim 16, wherein determining whether the one or more strokes likely represent a grapheme comprises generating a confidence score representing the likelihood that the one or more strokes represents a grapheme; and
wherein the particular recognition process is selected based at least on the generated confidence score.

20. The device of claim 16, wherein selecting the particular recognition process for processing the data comprises selecting a subset of the multiple recognizers to output the data indicating the one or more strokes.
